(19) United States
(12) Patent Application Publication
(10) Pub. No.: US 2009/0098522 A1
(43) Pub. Date: Apr. 16, 2009

(54) System for Simulation and Teaching Medical Care

(76) Inventor: Leonardo Marcovitz, South Miami, FL (US)

Correspondence Address: ROBERT M. SCHWARTZ, P.A., P.O. BOX 221470, HOLLYWOOD, FL, 33022, US

(21) Appl. No.: 12/250,735

(22) Filed: Oct. 14, 2008

Related U.S. Application Data
(60) Provisional application No. 60/979,548, filed on Oct. 12, 2007.

(51) Int. Cl. G09B 23/30

(52) U.S. Cl. 434/267

(57) ABSTRACT

The present invention is a system and method for simulating portable medical diagnostic instrument where an instructor interface is configured to communicate simulated medical information to simulated portable medical diagnostic instrument for teaching purposes to allow a trainee to read the simulated information on the simulated medical diagnostic instrument in a simulated real life environment.

### INDEX TO RELATED APPLICATIONS

This application claims the benefit of U.S. Provisional Application No. 60/979,548 filed Oct. 12, 2007, the disclosure of which is incorporated herein by reference in its entirety.

### BRIEF SUMMARY OF THE INVENTION

The system and method of the present invention provides a device to simulate a glucose or temperature reading for a student in a training or review session. A variety of nursing institutions are currently setting up medical simulation programs in which a mannequin is fitted with many sensors and cues for nurses to practice on them. The purpose of these simulations is to try to copy what treating a real patient would be like. The simulators can have heart beats, blood pressure and a variety of other measurable conditions. One very important measurement for a nurse to take on any kind of patient is a glucose measurement. The measurement is not meant to be limiting and any medical measurement may be used. Currently, when these medical simulations are performed, a professor or the person regulating the medical condition of the mannequin, orally tells the nurse or practitioner being tested (or practicing) what the glucose level of the mannequin is. This method of simulating or testing the nurses is highly inefficient because the nurse has to take no physical action or reading in order to accomplish the simulation of glucose and temperature readings. The device of the present invention is a novel way of simulating glucose and temperature readings in such a manner that the person performing on the simulator would have to actually take a device into their hands, put it near the mannequin (or real person) and only in that moment would the person on the computer send a glucose or temperature reading to the screen. The device makes a lasting impression on the nurse or practitioner so that they always remember to take and measure the glucose levels of their patient. Taking frequent glucose measurements in critical care and non critical care units at hospitals and clinics is now being cited in a wide variety of literature as very important. If the sentence: “tight glycemic control” is typed into Google® more than 100,000 hits appear on the website. The main elements of the device are: a program that lets the operator at the Bluetooth capable machine send a signal. A Bluetooth transceiver on a pcb (printed circuit board), a microcontroller, a display and a battery source so that the device is wireless.

The invention is a handheld device that mimics the outer appearance of a glucose meter tester. The device has a visible screen, which may be any type of display including, but not limited to, LCD (liquid crystal display), LED (light emitting diode), and the like, in which numbers can be displayed. The device is powered by a battery source and is wireless. The batteries are within the device casing with all the other electronic components that conform to the described device.

The purpose of the device is to display a number ranging from 0-999 with the option of putting at the end of the number the symbols mg/dl or the raised circle for degrees. The number that is displayed on the screen of the device is chosen by an operator at a computer or electronic device that can communicate with Bluetooth® capability (ability to send Bluetooth signals), or other communication or radio frequencies. The operator has a program on the computer which asks the user whether he/she wishes to send a temperature or a glucose measurement number to the screen of the device. After the operator fills in the input number they wish to send, the program in the computer sends the number or other information via Bluetooth to the electronic device's Bluetooth transceiver. The transceiver takes the signal and passes it on to a microcontroller which will then analyze the signal and display a temperature or glucose reading on the screen.

In one embodiment, the present invention is a system for simulating and teaching medical care having:

a. a portable medical diagnostic instrument;
b. an instructor interface configured for communication of medical information;
wherein said portable medical diagnostic instrument displays said medical information communicated from said instructor interface.

The system may further include a mannequin that is used to teach usage of the portable medical diagnostic instrument.

The system instructor interface communicates medical information either directly to a portable medical diagnostic instrument or to a mannequin configured to receive information communicated from the instructor interface.

If medical information is communicated directly to the mannequin, the portable medical diagnostic instrument interacts either directly or indirectly with the mannequin to display medical diagnostic information.

The instructor interface communicates medical information electronically, preferably using wireless electronic communication.

The present invention is also a method for teaching medical care comprising:

a. providing a portable medical diagnostic instrument configured to receive information communicated from an instructor interface;
b. providing a mechanism to respond to the information displayed on the medical diagnostic instrument.

In the method the information is directly communicated to the medical diagnostic instrument or information is communicated to a mannequin configured to receive the communicated information and the medical diagnostic instrument subsequently receives information from said mannequin.

It is an object of the present invention to provide a system and method for simulating and teaching medical care.

### BRIEF DESCRIPTION OF THE DRAWINGS

FIG. 1 is a diagram illustrating the components of one embodiment of the present invention.

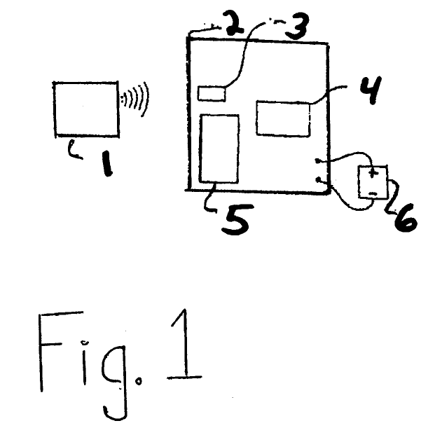

FIG. 2 is a flow chart demonstrating the program's steps of the present invention.

### DETAILED DESCRIPTION OF THE PREFERRED EMBODIMENTS

The system and method of the present invention is used to simulate and teach medical care. The system and method may be used to teach medical care of humans or animals.

An instructor communications means 1 is constructed and arranged to send a signal to a transceiver 3 on circuit board 2. A microcontroller 4 that is powered by battery 6 displays information on display 5.

The system comprises a portable medical diagnostic instrument and instructor operated communication interface. The portable medical diagnostic instrument however is merely a simulation of a specific medical instrument. In this case a glucose reading device to measure and report a digital readout the amount of glucose measured in mg/dl. The device of the present invention merely looks like a typical glucose meter. The device of the present invention uses a digital read out that receives information from the instructor for the amount of the glucose reading. The information is used by a student in the simulated setting. As used herein portable medical diagnostic instrument is used interchangeably and meant to mean the glucose meter simulator.

The portable medical diagnostic instrument may be any such instrument currently known or may be developed that is used for medical diagnosis. Such instruments include, but are not be limited to, blood glucose monitors, thermometers, blood pressure monitors, respiration monitors, heart monitors, portable x-ray equipment, EKG, and the like.

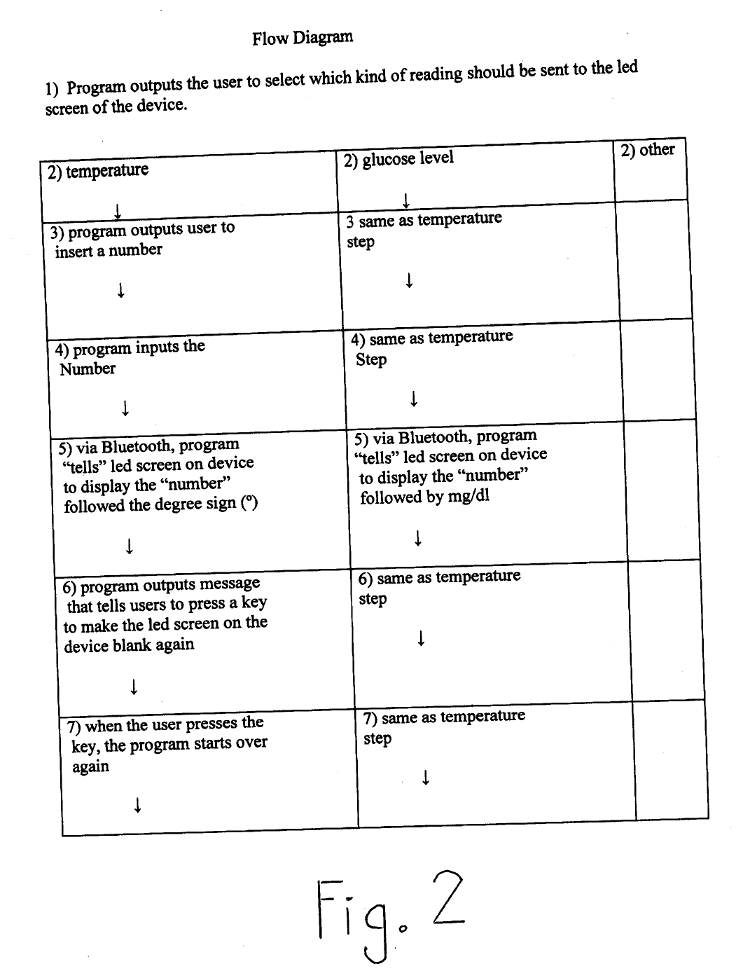

As shown in the flow chart of FIG. 2, a program can select a type or reading to be transmitted from an instructor controlled transmitter. For example, temperature or glucose measurements may be sent to a receiver and output a number and appropriate units such as degrees or mg/dl. The portable device may then be reset to receive another transmission.

The instructor may communicate medical diagnostic information directly to the portable medical diagnostic instrument. The user of the portable medical diagnostic instrument will then observe the medical diagnostic information provided and respond accordingly. Appropriate responses may include an oral response to an instructor or an electronic response through the portable medical diagnostic instrument.

Alternatively, the instructor may communicate medical diagnostic information to a mannequin configured to receive such information. The user of the portable medical diagnostic instrument will then use it in contact or proximity with the mannequin to simulate the actual measurement and communication of medical diagnostic information that normally would be measured from an actual patient. The user of the instrument will then provide an appropriate response. Appropriate responses may include an oral response to instructor or an electronic response communicated through the portable medical diagnostic instrument. As used herein, the simulation may be with a mannequin, a live person or merely with the practice device itself.

The instructor may communicate simulated medical diagnostic information by any communications mechanism. The communication may be mechanical or electrical. In a preferred embodiment, the communication will occur through wireless communication.

The system and method of the present invention may also include appropriate computer systems and software configured to communicate simulated medical diagnostic information and receive responses to the communication.

In a preferred method, the system and method of the present invention comprises an instructor transmitting blood glucose information that is received by a portable medical diagnostic instrument or glucose meter, or an instrument that resembles a portable medical diagnostic glucose meter. The meter is held by a trainee or student and has a display for reading blood glucose values transmitted thereto.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for simulating and teaching medical care comprising:
a. a simulated portable medical diagnostic instrument;
b. an instructor interface configured for communication of simulated medical information; wherein said portable medical diagnostic instrument displays said simulated medical information communicated from said instructor interface.

2. The system of claim 1 for further comprising a mannequin.

3. The system of claim 1 wherein said portable medical diagnostic instrument is any instrument configured to measure and display simulated medical information of a patient

4. The system of claim 1 wherein said simulated portable medical diagnostic instrument is a blood glucose meter, thermometer, arterial blood gas meter, heart monitor, portable x-ray, respiration monitor, blood pressure monitor, and the like.

5. The system of claim 1 wherein said instructor interface communicates simulated medical information directly to a simulated portable medical diagnostic instrument.

6. The system of claim 2 wherein said instructor interface communicates simulated medical information to the mannequin configured to receive information communicated from the instructor interface.

7. The system of claim 6 wherein said instructor interface communicates simulated medical information directly to the mannequin which is configured to transmit simulated medical information to a portable medical diagnostic instrument.

8. The system of claim 1 wherein said instructor interface communicates simulated medical information electronically.

9. The system of claim 1 wherein said instructor interface communicates simulated medical information using wireless electronic communication.

10. A method for teaching medical care comprising:
a. providing a simulated portable simulated medical diagnostic instrument configured to receive simulated information communicated from an instructor interface;
b. providing a mechanism to respond to the simulated information displayed on the simulated medical diagnostic instrument.

11. The method of claim 10 wherein the simulated information is directly communicated to the simulated medical diagnostic instrument.

12. The method of claim 10 wherein the simulated information is communicated to a mannequin configured to receive the communicated simulated information and the simulated medical diagnostic instrument subsequently receives simulated information from said mannequin.
